(19) United States
(12) Patent Application Publication
(10) Pub. No.: US 2018/0326797 A1
(43) Pub. Date: Nov. 15, 2018

(54) RUN-FLAT INSERT

(71) Applicant: EUROPLAST-NYCAST GmbH, Velbert-Roebbeck (DE)

(72) Inventor: Hans-Georg SEELIG, Essen (DE)

(21) Appl. No.: 15/748,086

(22) PCT Filed: Feb. 2, 2016
(86) PCT No.: PCT/EP2016/052150

§ 371 Date: Jul. 18, 2018

(30) Foreign Application Priority Data
Jul. 30, 2015 (EP) 15179080.5

(51) Int. Cl. B60C 17/06

(52) U.S. Cl. CPC B60C 17/06

(57) ABSTRACT

A braceable run-flat insert for a vehicle wheel has subelements forming a circular ring. The subelements are connected in an articulated manner or braced by a clamping system.

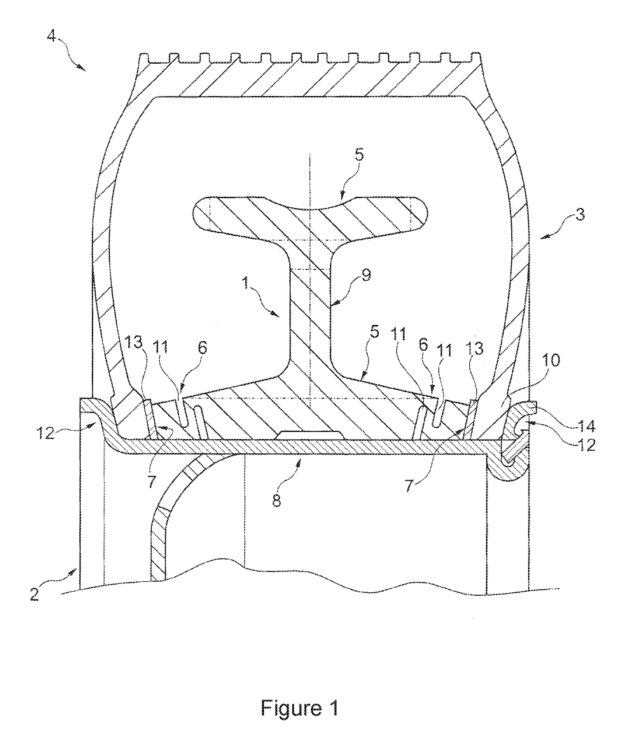

To prevent the ingress of dirt, the cross section of the subelements forms a T shape on the tire side. The crossbar of the T is a running surface for the tire when there is a tire defect. The cross section of the subelements form an approximate T shape on the rim side. Two lateral end points fit on the rim base and rest on the latter in the fitted state. The tire-side T and the rim-side T are connected by a radially running web. The lateral end points of the crossbar of the rim-side T-shaped configuration can be displaced toward one another against a restoring force by an elastic subregion between the two end points of the crossbar.

The invention relates to a braceable run-flat insert for a motor vehicle wheel comprising a rim and an air-filled tire, which has on each of both sides a tire bead and with these two tire beads is arranged on the rim, with at least two, in particular three, subelements in the form of segments of a circular ring, wherein subelements that are adjacent to one another are in each case either connected to one another in an articulated manner or can be braced with respect to one another by means of a clamping system.

Such systems are known in practice in a wide variety of distinctive designs. It is disadvantageous here that, when the air pressure inside the tire is reduced, as is often carried out for example when driving off-road or on sand to increase the ground contact area and obtain better traction, the tire beads are no longer securely held on the rim shoulder, so that sand and/or dirt can get in. This, however, inevitably leads to damage occurring sooner or later.

The object of the invention is to avoid the aforementioned disadvantages and to provide a possible way of reliably preventing the ingress of dirt irrespective of the air pressure in the tire.

This object is achieved in the case of a run-flat insert of the generic type by the cross section of the subelements being formed in a T shape on the tire side, the crossbar of the T-shaped configuration serving as a running surface for the tire when there is a tire defect, and the cross section of the subelements being formed in an approximate T shape on the rim side, with two lateral end points, wherein the crossbar of the T-shaped configuration serves for fitting on the rim base and rests on the latter in the fitted state, wherein the tire-side T-shaped configuration and the rim-side T-shaped configuration are connected to one another, in particular by way of a radially running web, wherein the lateral end points of the crossbar of the rim-side T-shaped configuration can be displaced toward one another against a restoring force by at least one distinctively elastically designed subregion provided between the two end points of the crossbar. In this way, when the tire is fitted, the tire beads are securely held against the rim shoulder by the pressing pressure that is to this extent produced by the lateral end points of the crossbar of the rim-side T-shaped configuration.

Advantageously, at least one distinctly elastically designed subregion can be formed as a meandering spring region, so that a corresponding run-flat insert can be easily produced for example by finished casting. The spring region may in this case be formed as running along the longitudinal extent of the run-flat insert, that is to say be provided with the same contour all around.

The meandering spring region can be also formed by at least two respectively opposing, preferably slanted incisions.

According to the invention, the subelements may consist of a molded material, in particular of plastic and/or of a composite material.

The material of the subelements may preferably have only a low resilience, such that sufficient stability and load-bearing capacity are provided.

The material of the subelements may for example have a tensile modulus of elasticity of 1000 to 2000 MPa, in particular of about 1512 MPa, and/or have an elongation at break of 100 to 400%, in particular of about 270%.

Also, the material of the subelements can have a rupture strength of 20 to 60 MPa, in particular of about 47 MPa, and/or can have a hardness of about 50 to 80 Shore D, in particular of about 74 Shore D.

In a preferred embodiment of the invention, the distance of the displacement, that is to say the “spring excursion”, of the two end points of the crossbar toward one another against the restoring force can be about 2 to 20 mm, advantageously 4 to 16 mm and preferably 6 to 12 mm.

According to the invention, at least the crossbars of the rim-side T-shaped configuration of the subelements, preferably the entire subelements, may have a smaller width in those end regions of their longitudinal extent in which they are connected to one another and/or are braced with respect to one another than in the remaining regions lying between these end regions. Consequently, the regions of the subelements in which they are connected to one another and/or braced with respect to one another are not subjected to any lateral loads, or at least only to relatively low lateral loads.

In this case, the smaller width may be 2 to 20 mm, advantageously 4 to 16 mm and preferably 6 to 12 mm. This may in particular correspond to the “spring excursion” of the two end points of the crossbar toward one another against the restoring force.

The invention also relates to a motor vehicle wheel with a rim, with an air-filled tire, which has on each of both sides a tire bead and with these two tire beads is arranged on the rim, and with a braceable run-flat insert arranged on the rim within the tire.

To solve the problem addressed by the invention that is mentioned at the beginning, it is intended to use a run-flat insert according to the invention. The rim may in this case be a multi-part flat-base rim. The rim may also be provided with a beadlock system.

According to the invention, the lateral end points of the crossbar of the rim-side T-shaped configuration of the subelements may respectively lie pressed against the corresponding tire bead under pressure.

Alternatively, an annular intermediate element, preferably consisting of high-grade steel or a polyolefin or PTFE, may be provided at least between one of the two lateral end points of the crossbar of the rim-side T-shaped configuration of the subelements and the respective corresponding adjacent tire bead, wherein the lateral end points of the crossbar of the rim-side T-shaped configuration of the subelements respectively lie pressed against the one side of the annular intermediate element and the corresponding tire bead lies pressed against the other side of the annular intermediate element, in each case under pressure.

Consequently, when there is one intermediate element, the run-flat insert is decoupled on one side from the corresponding tire bead and, when there are two intermediate elements, the run-flat insert is decoupled on both sides from the two tire beads and can “slip” or glide on the rim. The beadlock system has the effect nevertheless of providing a secure seating of the corresponding tire bead on the rim. When driving off-road with reduced tire pressure, or else when an emergency occurs as a result of a tire defect, the possibility of ingress of dirt between the rim shoulder and the tire bead, which could lead to premature overall failure, is avoided.

The material thickness of the intermediate element may in this case preferably be 2 to 5 mm, but higher or lower material thicknesses are also possible. The annular intermediate element may—in keeping with the configuration of the tire bead—in this case be slightly slanted. This may likewise apply to the assigned lateral end point of the crossbar of the run-flat insert or even both lateral end points.

There follows an explanation of an exemplary embodiment of the invention, which is represented in the drawing. The single FIGURE shows the cross section of a subelement of a braceable run-flat insert 1, wherein the run-flat insert 1 consists of three subelements in the form of segments of a circular ring. Subelements that are adjacent to one another are in each case either connected to one another in an articulated manner or can be braced with respect to one another by means of a clamping system.

The run-flat insert 1 is intended for a motor vehicle wheel, which consists of a rim 2 with a rim base 8 and lateral rim shoulders 12, which is not represented in the drawing, and also an air-filled tire 3, which is likewise not shown in the drawing, wherein the tire 3 has on each of both sides a tire bead 10 and with these two tire beads 10 is arranged on the rim 2 and lies against the rim shoulders 12.

As shown in the FIGURE, the cross section of the subelements is formed in a T shape on the tire side, the upper crossbar 5 of the T-shaped configuration serving as a running surface for the tire 3 when there is a tire defect. The cross section of the subelements is also formed in an approximate T shape on the rim side, with two lateral end points 7, wherein the crossbar 5 of the T-shaped configuration serves for fitting on the rim base 8 and rests on the latter in the fitted state.

The tire-side T-shaped configuration and the rim-side T-shaped configuration are connected to one another by way of a radially running web 9

Between the two end points 7 of the crossbar 5, a distinctively elastically designed subregion 6 is provided on each of both sides, whereby the lateral end points 7 of the crossbar 5 of the rim-side T-shaped configuration can be displaced toward one another against a restoring force.

When the tire 3 is fitted, the tire beads 10 are consequently securely held against the respective rim shoulder 12 by the pressing pressure that is to this extent produced by the lateral end points 7 of the crossbar 5 of the rim-side T-shaped configuration.

The distinctly elastically designed subregions 6 are in each case formed as a meandering spring region, which is formed by two opposing, slanted incisions 11. The spring region in this case runs along the longitudinal extent of the run-flat insert 1.

The rim 2 is provided on the right-hand side with a beadlock system, which comprises inter alia a ring 14 forming the right-hand rim shoulder 12.

An annular intermediate element 13 is provided on each of both sides between the respective lateral end point 7 of the crossbar 5 of the rim-side T-shaped configuration of the subelements and the respective corresponding adjacent tire bead 10. Consequently, on the one hand the lateral end points 7 of the crossbar 5 of the rim-side T-shaped configuration of the subelements respectively lie pressed against the one side of the corresponding annular intermediate element 13 under pressure, and on the other hand the corresponding tire beads 10 respectively lie pressed against the other side of the respectively corresponding annular intermediate element 13 under pressure. The friction which would result if the run-flat insert 1 were to lie directly against the tire beads 10 is consequently avoided, so that the run-flat insert can slide on the rim 2 within the tire 3.

1. A braceable run-flat insert (1) for a motor vehicle wheel (4) comprising a rim (2) and an air-filled tire (3), which has on each of both sides a tire bead (10) and with these two tire beads (10) is arranged on the rim (2), with at least two, in particular three, subelements in the form of segments of a circular ring, wherein subelements that are adjacent to one another are in each case either connected to one another in an articulated manner or can be braced with respect to one another by means of a clamping system, wherein the cross section of the subelements is formed in a T shape on the tire side, the crossbar (5) of the T-shaped configuration serving as a running surface for the tire (3) when there is a tire defect, and the cross section of the subelements is formed in an approximate T shape on the rim side, with two lateral end points, wherein the crossbar (5) of the T-shaped configuration serves for fitting on the rim base (8) and rests on the latter in the fitted state, wherein the tire-side T-shaped configuration and the rim-side T-shaped configuration are connected to one another, in particular by way of a radially running web (9), wherein the lateral end points of the crossbar (5) of the rim-side T-shaped configuration can be displaced toward one another against a restoring force by at least one distinctively elastically designed subregion (6), provided between the two end points of the crossbar (5), wherein at least one distinctly elastically designed subregion (6) is formed as a meandering spring region.

2. The braceable run-flat insert (1) as claimed in claim 1, wherein at least one distinctly elastically designed subregion (6) is formed as a meandering spring region.

3. The braceable run-flat insert (1) as claimed in claim 1, wherein the meandering spring region is formed by at least two respectively opposing, preferably slanted incisions (11).

4. The braceable run-flat insert (1) as claimed in claim 1, wherein the subelements consist of a molded material, in particular of plastic and/or of a composite material.

5. The braceable run-flat insert (1) as claimed in claim 1, wherein the material of the subelements has only a low resilience.

6. The braceable run-flat insert (1) as claimed in claim 1, wherein the material of the subelements has a tensile modulus of elasticity of 1000 to 2000 MPa, in particular of about 1512 MPa, and/or has an elongation at break of 100 to 400%, in particular of about 270%.

7. The braceable run-flat insert (1) as claimed in claim 1, wherein the material of the subelements has a rupture strength of 20 to 60 MPa, in particular of about 47 MPa, and/or has a hardness of about 50 to 80 Shore D, in particular of about 74 Shore D.

8. The braceable run-flat insert (1) as claimed in claim 1, wherein the distance of the displacement of the two end points of the crossbar (5) toward one another against the restoring force is about 2 to 20 mm, advantageously 4 to 16 mm and preferably 6 to 12 mm.

9. The braceable run-flat insert (1) as claimed in claim 1, wherein at least the crossbars (5) of the rim-side T-shaped configuration of the subelements, preferably the entire subelements, have a smaller width in those end regions of their longitudinal extent wherein they are connected to one another and/or are braced with respect to one another than in the remaining regions lying between these end regions.

10. The braceable run-flat insert (1) as claimed in claim 9, wherein the smaller width is 2 to 20 mm, advantageously 4 to 16 mm and preferably 6 to 12 mm.

11. A motor vehicle wheel (4) with a rim (2), with an air-filled tire (3), which has on each of both sides a tire bead (10) and with these two tire beads (10) is arranged on the rim (2), and with a braceable run-flat insert (1) arranged on the rim (2) within the tire (3), wherein the run-flat insert (1) is formed as claimed in claim 1.

12. The motor vehicle wheel (4) as claimed in claim 11, wherein the rim (2) is provided with a beadlock system.

13. The motor vehicle wheel (4) as claimed in claim 11, wherein the rim (2) is a multi-part flat-base rim.

14. The motor vehicle wheel (4) as claimed in claim 11, wherein the lateral end points (7) of the crossbar (5) of the rim-side T-shaped configuration of the subelements respectively lie pressed against the corresponding tire bead (10) under pressure.

15. The motor vehicle wheel (4) as claimed in claim 11, wherein an annular intermediate element (13), preferably consisting of high-grade steel or a polyolefin, is provided at least between one of the two lateral end points (7) of the crossbar (5) of the rim-side T-shaped configuration of the subelements and the respective corresponding adjacent tire bead (10), wherein the lateral end points (7) of the crossbar (5) of the rim-side T-shaped configuration of the subelements respectively lie pressed against the one side of the annular intermediate element (13) and the corresponding tire bead (10) lies pressed against the other side of the annular intermediate element (13), in each case under pressure.
